(19) United States
(12) Patent Application Publication
(10) Pub. No.: US 2018/0308180 A1
(43) Pub. Date: Oct. 25, 2018

(54) Systems Methods Devices Circuits and Computer Executable Code for Impression Measurement and Evaluation

(71) Applicant: B.Z.W LTD., Giva'tayim (IL)

(72) Inventors: Moshe Bar, Ramat Hasharon (IL); Haim Zilbershats, Tel-Aviv (IL)

(21) Appl. No.: 15/797,079

(22) Filed: Oct. 30, 2017

Related U.S. Application Data
(60) Provisional application No. 62/414,745, filed on Oct. 30, 2016.

(51) Int. Cl. G06Q 50/00; G06F 17/30; G06N 3/08

(52) U.S. Cl. CPC G06Q 50/01; G06N 3/08; G06F 17/30274; G06F 17/30867

(57) ABSTRACT

Disclosed are systems, methods, devices, circuits and computer executable code for impression measurement and evaluation. A mobile device is used to acquire a digital depiction of a real-world object and for the selection of one or more raters for providing feedback to the object depiction. A system server is used to select a depiction presentation scheme for the object depiction. One or more rater modules, are used for presenting the received object depiction and a rater feedback interface, in accordance with the presentation scheme, for rater feedback.

### RELATED APPLICATIONS

This application claims the priority of applicant's U.S. Provisional Patent Application No. 62/414,745, filed Oct. 30, 2016. The disclosure of the above mentioned 62/414,745, Provisional patent application, is hereby incorporated by reference in its entirety for all purposes.

### FIELD OF THE INVENTION

The present invention generally relates to the fields of sentiment measurement and analysis and of opinion, preference and emotion mining more specifically, the present invention relates to systems, methods, devices, circuits and computer executable code for impression measurement, evaluation and inference.

### BACKGROUND

People caring what other people think about them, is a basic part of human nature. Assessing what other people really think about us, however, is hard if not impossible. Most people react to their first impression subconsciously, but may have difficulty assessing their true first impression of a person or an object. First impressions are formed blazingly fast, yet they are long-lasting. First impressions have a significant effect on our lives, yet we are largely ignorant about the impressions that we make, failing to assess and know what people really think about us or about the people, animals, plants and objects surrounding us.

Accordingly, there remains a need in the fields of sentiment measurement and analysis and of opinion and emotion mining, for systems, methods, devices, circuits and computer executable code for evaluation of the impression a person or an object makes on other people.

### SUMMARY OF THE INVENTION

The present invention includes systems, methods, devices, circuits and computer executable code for impression measurement and evaluation.

According to some embodiments, there may be provided Systems Methods Devices Circuits and Computer Executable Code for Impression Measurement, Evaluation and Inference, wherein an object is depicted, presented to raters and feedback from the raters is processed to generate impression measurements and evaluations of the object and/or attributes thereof.

An ‘Object’, as used herein, may refer to any digitally depictable: inanimate object, thing, article, or item; living organism, human, animal, plant, or other; view, scene, or environment; and/or any part or combination thereof.

An Object Depiction, in accordance with some embodiments, may take the form of any visual, acoustic, taste, smell and/or feel based representation of an object, such as, but not limited to, any combination of an image, a video, a sound, a text and/or other. The depiction may take the form of a digital representation and/or of any other form of representation, known today, or to be devised in the future.

In some of the following descriptions, a User Computerized Device and a Rater Computerized Device are utilized for acquiring object depiction and uploading them and for their presentation to Raters and collection of feedback in response. This is, however, not to limit the teachings herein. For example, object depiction presentation for rating can, in accordance with some embodiments, be made on any display or output means and/or may take the form of a physical presentation of the rated object(s). Raters' response collection, in accordance with some embodiments, may be based on, or take into consideration, physiological measures and/or physiological parameters of raters providing the feedback. Such measures/parameters may include, but are not limited to: heart rate, pupil diameter and eye movements, vocal responses, blood pressure, skin conductivity and/or others.

According to some embodiments, a User Computerized Device may be utilized to acquire an Object Depiction in the form of a digital representation (e.g. image) of an object. The Object Depiction, or derivations thereof, may be communicated to a System Server, optionally processed; and relayed for presentation (e.g. display) over one or more Rater Computerized Devices selected from a Raters Database storing a pool of rater's records. According to some embodiments, the Object Depiction, may be presented in accordance with a one or more presentation schemes affecting the Object Depiction and/or its presentation characteristics.

According to some embodiments, Rater Computerized Devices may be utilized for receiving Raters' input feedbacks to the Object Depiction(s) presented to them and communicating received feedback data to the System Server. The System Server may process the feedback data as to generate one or more Impression Parameters and relay them, or a derivation thereof, for presentation over the User Computerized Device utilized to acquire the original Object Depiction.

According to some embodiments, any computerized device(s), instead or in combination with a personal/rater/user computerized device, may be utilized by a system in accordance with some embodiments, for presenting raters with user acquired object depictions and for receiving, processing and presenting raters' feedbacks therefor and/or evaluations based thereof.

According to some embodiments, a given Computerized Device may operate as a User Computerized Device, a Rater Computerized Device, or as both—a User and a Rater Device. Accordingly, the device user of a Computerized Device including both User and Rater capabilities, may both upload and receive feedback to his own Object Depictions and rate depictions uploaded by other Users.

A User Module, in accordance with some embodiments, may be installed onto and/or integrated into the User Computerized Device and may include: (1) an Object Depiction Logic for utilizing one or more input components (e.g. camera, microphone, other sensors) of the User Computerized Device for acquiring the Object Depiction and for providing the User with tools for customizing the acquired Depiction prior to its uploading; (2) an Attribute Selection Logic for receiving User chosen attribute(s), of the Object, for which impression evaluation is requested; (3) a Rater Selection Logic for receiving User selection, profiling and/or segmentation definitions of the type of Raters and/or of specific Raters—from which the User would like to receive impression feedback to the Depicted Object or attributes thereof; (4) an Upload Logic for managing the communication of the: Object Depiction, user selected Object attributes and/or user selected Object raters, to the System Server; (5) an Evaluation Presentation Logic for utilizing one or more output components (e.g. display, speaker, other) of the User Computerized Device for presenting the Raters' Evaluation results for the requested Object Depiction and/or attributes to the User; and/or (6) a User Recognition Feedback Logic for automatically triggering Rater feedback to an uploaded user depiction—for example, a portrait image acquired/utilized as part of a User face recognition process (e.g. at user's mobile device unlocking/login); and providing the User with Raters' feedback based evaluations—for example, in the form of: designations, ratings, labels, and/or tags—to his uploaded face depiction and/or attributes thereof.

A System Server, in accordance with some embodiments, may include any combination of the following components.

(1) a Raters Group Selection Logic for analyzing communicated User selection, profiling and/or segmentation definitions of raters and, for determining, at least partially based the analysis results, the specific group of Raters associated Computerized Devices to which the Object Depiction will be communicated/dispatched/multicasted for feedback;

(2) a Depiction Processing and Presentation Logic for determining the schemes, characteristics and/or parameters associated with the presentation of the Object Depiction over the specific group of Raters associated Computerized Devices determined/selected. Object Depiction presentation schemes, characteristics and/or parameters, in accordance with some embodiments, may include or relate to: (a) the time length, or the limited time length, of presentation of the Object Depiction to the Rater(s); (b) the size (i.e. file/data size/amount, e.g. number of bytes), resolution and/or quality level of the Object Depiction version communicated and presented to the Rater(s); (c) the utilization of a distraction filter for optimizing the presentation to minimize unwanted distractions affecting Rater's impression of the Object; and/or (d) Skew preventing presentation techniques for preventing, moderating and/or minimizing or eliminating biased/tilted ratings.

(3) a Rater Feedback Evaluation Logic for processing the Raters' feedback data and generating one or more Impression Parameters. Generated Impression Parameters, in accordance with some embodiments, may include: (a) Impression Parameters based on received rater's feedback rating(s); (b) Impression Parameters based on Secondary Information such as the characteristics of the Rater's response execution; (c) Combined Impression Parameters Calculation, based on a combination of received rater's feedback rating(s) and secondary information; (d) Impression Parameters calculated as a moving average of that parameter for a specific rater, or set of raters, over time, based on his/her/their accumulating responses/ratings; and/or (e) Combined Raters' Group perception of object/attributes based on feedback signals received from a plurality of raters and calculation of group indicative Impression Parameters.

(4) an Evaluation Presentation Logic for selecting a Rater's Evaluation presentation scheme; customizing it based on the Impression Parameters generated for the current Evaluation; and generating and relaying the associated presentation/rendering parameters to the User Computerized Device from which the Object Depiction was originally uploaded. According to some embodiments, the Rater's Evaluation presentation scheme and its customizing may be based on: System rules and settings, User settings/preferences and/or Rater settings/preferences.

A Rater Evaluation, in accordance with some embodiments, may be presented to the User: (a) as an average, or other statistical index, between the ratings of participating raters; (b) as a weighted average based on system accumulated knowledge about specific Raters and their preferences; and based thereof, about their level of relevance to the current Evaluation; (c) as a breakdown of the participating Raters target group to multiple rater sub-groups/segments/clusters, each with a respective calculated average, weighted-average and/or other statistical index; and/or (d) as an asynchronous or a multi-evaluation/evolving-evaluation presentation, wherein the relaying for User presentation of an initially generated Impression Parameters based Evaluation is: (i) delayed until a threshold number/amount/quality of Raters' feedbacks is received by the system; and/or (ii) executed and presented based on partial feedback data available, optionally followed by the relying and presentation of updated Impression Parameters based Evaluations as further feedback data is received by the system and further Impression Parameters are generated. Notifications indicating a delay-in/time-to Evaluation presentation (option (d)i), or an ‘Initial/Partial-Data-Based’ Evaluation (option (d)ii), may be generated and respectively relayed and presented to the associated User(s).

(5) a Rater Feedback Analysis and Applications Module for processing and analyzing system collected Raters' feedbacks and facilitating applications based thereof. Rater feedback processing, analysis and application, in accordance with some embodiments, may, for example, include any combination of the following: (a) Analyzing accumulated raters feedbacks to determine the preferences of specific raters and/or specific rater groups/segments; (b) Generating content targeting data for Raters, based on their ‘preference history’ as expressed in their accumulated feedbacks, and utilizing/offering generated targeting data; (c) Identifying rating characteristics within multiple ratings of depictions of specific objects/attributes; and revealing trends and patterns of general interest associated with the specific objects/attributes; (d) Calculating and providing perceived rater feedbacks based on the statistical analysis of stored information from previous ratings (without receiving further human ratings); (e) Applying an Internet bot for inviting potentially relevant Raters based on system-determined rater groups for which it seeks additional raters; and/or (f) Building and applying a neural network model—trained with sets of object/attribute depictions and their respective actual human raters' ratings—to later generate perceived rater feedbacks for new object/attribute depictions (without receiving further human ratings).

A Rater Module, in accordance with some embodiments, may be installed onto and/or integrated into the Rater Computerized Device and may include: (1) an Object Depiction Presentation Logic for utilizing one or more output components (e.g. display, speaker, other) of the Rater Computerized Device for presenting the Depiction for Rater assessment and feedback; (2) a Rating Interface for presenting the Rater with rating tools and receiving his feedback inputs; and/or (3) a Ratings Upload Logic for managing the communication of the feedback to the System Server.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1A is a block diagram, showing the main components and component relationships of an exemplary system for impression measurement and evaluation, in accordance with some embodiments;

FIG. 1B is a flowchart, showing the main process steps executed by an exemplary system for impression measurement and evaluation, in accordance with some embodiments, a flowchart;

FIG. 2 is a block diagram, showing in further detail the main components and component relationships of an exemplary user module, in accordance with some embodiments;

FIG. 3A is a screenshot of an exemplary object depiction logic interface of a user module/application, in accordance with some embodiments;

FIG. 3B is a screenshot of an exemplary object depiction logic interface of a user module/application, in accordance with some embodiments;

FIG. 3C is a screenshot of an exemplary attribute selection logic interface of a user module/application, in accordance with some embodiments;

FIG. 3D is a screenshot of an exemplary rater selection logic interface of a user module/application, in accordance with some embodiments;

FIG. 3E is a screenshot of an exemplary rater selection logic interface of a user module/application, in accordance with some embodiments;

FIG. 4 is a block diagram, showing in further detail the main components and component relationships of an exemplary system server, in accordance with some embodiments;

FIG. 5 is a block diagram, showing in further detail the main components and component relationships of an exemplary rater module, in accordance with some embodiments;

FIG. 6A is a screenshot of an exemplary object depiction presentation logic interface of a rater module/application, in accordance with some embodiments;

FIG. 6B is a screenshot of an exemplary object depiction presentation logic interface of a rater module/application, in accordance with some embodiments;

FIG. 6C is a screenshot of an exemplary object depiction presentation logic interface of a rater module/application, in accordance with some embodiments;

FIG. 6D is a screenshot of an exemplary rating interface of a rater module/application, in accordance with some embodiments; and

FIG. 7 is a screenshot of an exemplary feedback impression results presentation of a user module/application, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

The present invention includes systems, methods, devices, circuits and computer executable code for impression measurement and evaluation.

According to some embodiments, there may be provided Systems Methods Devices Circuits and Computer Executable Code for Impression Measurement, Evaluation and Inference, wherein an object is depicted, presented to raters and feedback from the raters is processed to generate impression measurements and evaluations of the object and/or attributes thereof. An ‘Object’, as used herein, may refer to any digitally depictable: inanimate object, thing, article, or item; living organism, human, animal, plant, or other; view, scene, or environment; and/or any part or combination thereof.

According to some embodiments, a User Computerized Device may be utilized to acquire an Object Depiction in the form of a digital representation (e.g. image) of an object. The Object Depiction, or derivations thereof, may be communicated to a System Server, optionally processed; and relayed for presentation (e.g. display) over one or more Rater Computerized Devices selected from a Raters Database storing a pool of rater's records. According to some embodiments, the Object Depiction, may be presented in accordance with a one or more presentation schemes affecting the Object Depiction and/or its presentation characteristics.

According to some embodiments, Rater Computerized Devices may be utilized for receiving Raters' input feedbacks to the Object Depiction(s) presented to them and communicating received feedback data to the System Server. The System Server may process the feedback data as to generate one or more Impression Parameters and relay them, or a derivation thereof, for presentation over the User Computerized Device utilized to acquire the original Object Depiction.

According to some embodiments, a given Computerized Device may operate as a User Computerized Device, a Rater Computerized Device, or as both—a User and a Rater Device. Accordingly, the device user of a Computerized Device including both User and Rater capabilities, may both upload and receive feedback to his own Object Depictions and rate depictions uploaded by other Users.

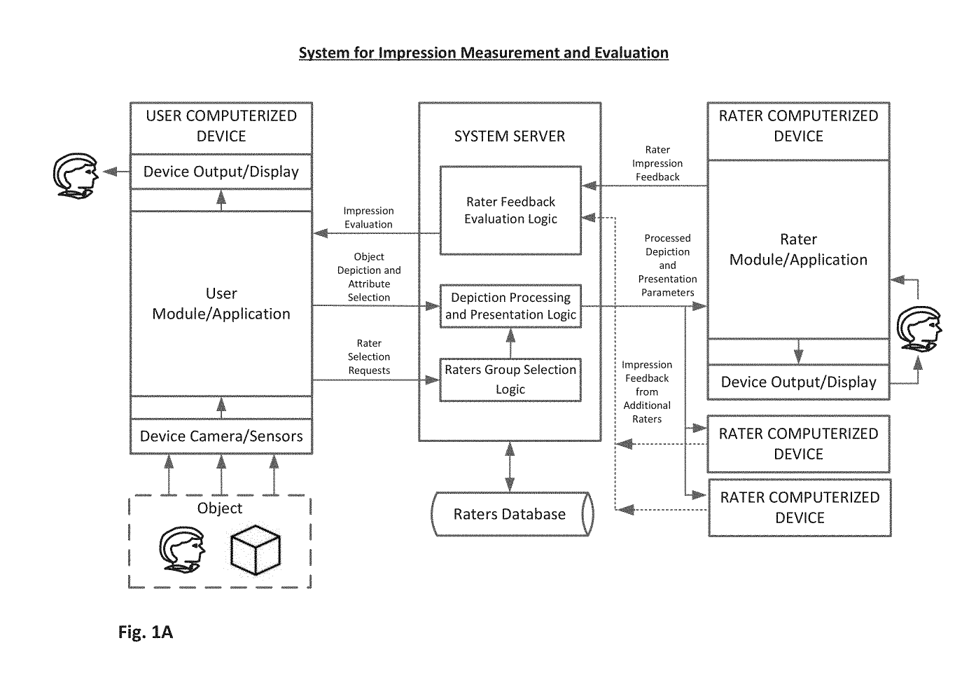

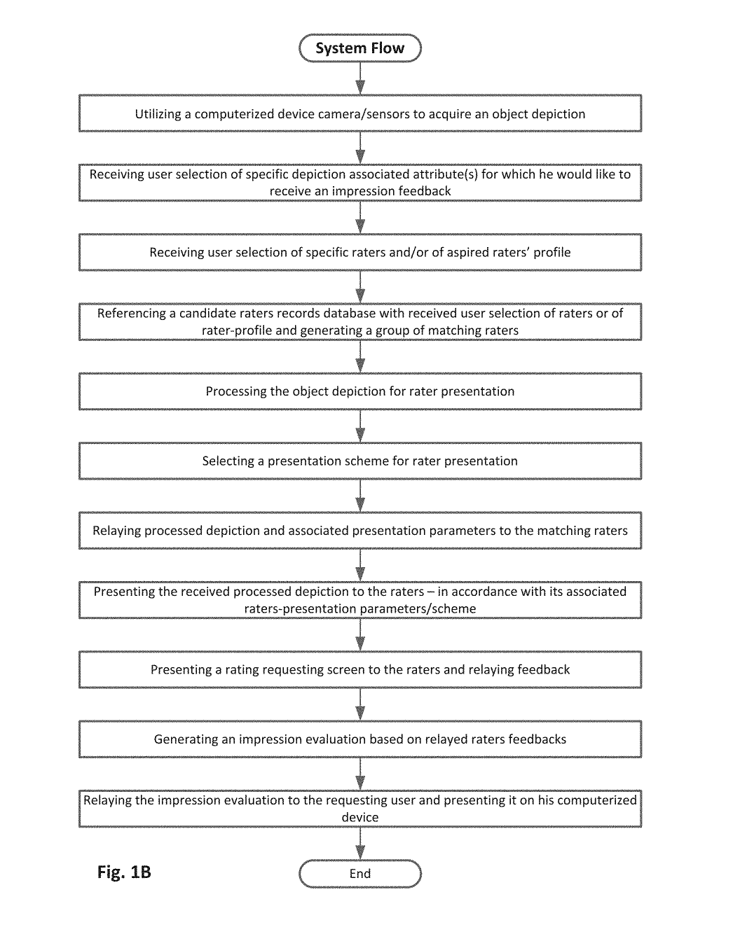

In FIG. 1A there is shown, in accordance with some embodiments, the main components and component relationships of an exemplary system for impression measurement and evaluation. The shown system includes a user module/application integrated-into/installed-onto a user computerized device. The user module/application utilizes the device camera/sensors to acquire an object depiction and allows for the user to select specific depiction associated attribute(s) for which he would like to receive impression feedback. The depiction and selected attributes, along with a specific per-person, or profile based, selection of raters for rating thereof, are communicated to the system server.

Upon receipt of the depiction and the related data, the shown raters group selection logic of the system server, references a raters' database including records of candidate raters. Based on the user's selections made, a sub group of matching raters is selected from within the candidates. The received depiction is processed by the depiction processing and presentation logic of the server, as described herein; and a presentation scheme for its presentation to the raters is selected. The processed depiction and its associated raters-presentation parameters are then relayed by the server to each of the matching raters in the sub group, for feedback.

The shown system includes multiple rater modules/applications integrated-into/installed-onto respective rater computerized devices. The rater module/application, of each given rater in the matching raters sub group that received the depiction, presents the received processed depiction—in accordance with its associated raters-presentation parameters—over the display of the rater's device. Following to the presentation of the depiction, a rating screen is presented to the rater, requesting his impression feedback, which feedback is then relayed back to the system server.

The shown rater feedback evaluation logic of the system server, generates an impression evaluation based on some or all of the feedbacks received from raters for the specific depiction being rated. The impression evaluation is relayed back to the initiating/requesting user and presented to the user over/through the display and/or other output components of his user computerized device.

In FIG. 1B there is shown, in accordance with some embodiments, a flowchart of the main process steps executed by an exemplary system for impression measurement and evaluation. Shown steps include: (1) Utilizing a computerized device camera/sensors to acquire an object depiction; (2) Receiving user selection of specific depiction associated attribute(s) for which he would like to receive an impression; (3) Receiving user selection of specific raters and/or of aspired raters' profile; (4) Referencing a candidate raters records database with received user selection of raters or of rater-profile and generating a group of matching raters; (5) Processing the object depiction for rater presentation; (6) Selecting a presentation scheme for rater presentation; (7) Relaying processed depiction and associated presentation parameters to the matching raters; (8) Presenting the received processed depiction to the raters—in accordance with its associated raters-presentation parameters/scheme; (9) Presenting a rating requesting screen to the raters and relaying feedback; (10) Generating an impression evaluation based on relayed raters feedbacks; and (11) Relaying the impression evaluation to the requesting user and presenting it on his computerized device.

A User Module, in accordance with some embodiments, may include any combination of electric circuitry and/or computer executable code and may be installed onto and/or integrated into the User Computerized Device.

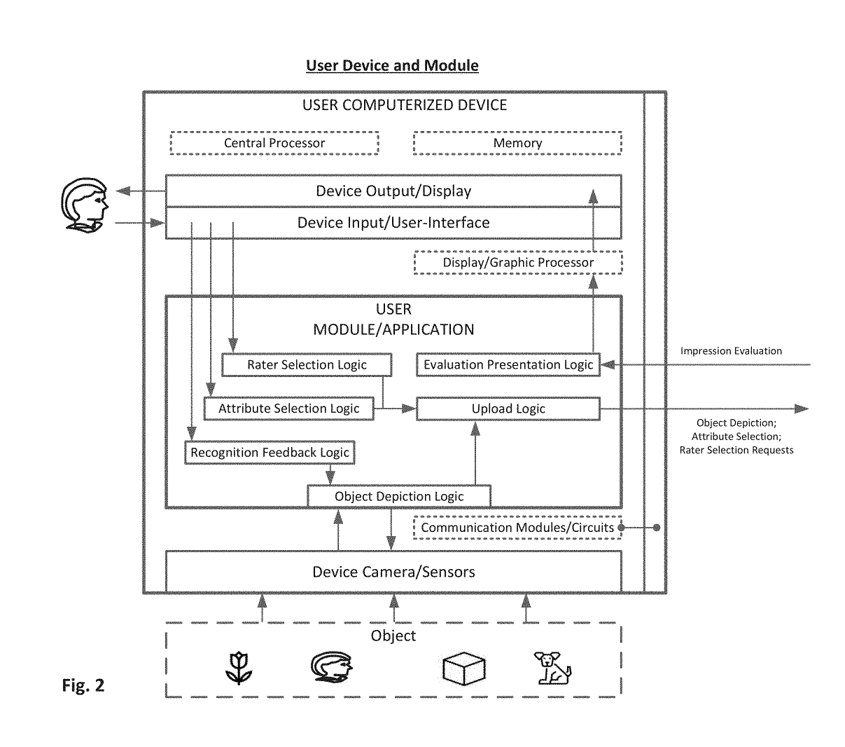

In FIG. 2 there are shown in further detail, in accordance with some embodiments, the main components and component relationships of an exemplary user module.

The shown user module is installed onto or integrated into a user computerized device. The shown device comprises at least a central processor, a memory, a graphic processor and communication circuitry. the shown user module includes: an object depiction logic for utilizing one or more input components (e.g. camera, microphone, other sensors) of the user computerized device for acquiring the object depiction and for providing the user with tools for customizing the acquired depiction prior to its uploading; an attribute selection logic for receiving user chosen attribute(s), of the object, for which impression evaluation is requested; a rater selection logic for receiving user selection, profiling and/or segmentation definitions of the type of raters and/or of specific raters—from which the user would like to receive impression feedback to the depicted object or attributes thereof; an upload logic for managing the communication of the: object depiction, user selected object attributes and/or user selected object raters, to the system server; an evaluation presentation logic for utilizing one or more output components (e.g. display, speaker, other) of the user computerized device for presenting the raters' evaluation results for the requested object depiction and/or attributes to the user; and a user recognition feedback logic for automatically triggering rater feedback to an uploaded user depiction—for example, a portrait image acquired/utilized as part of a user face recognition process (e.g. at user's mobile device unlocking/login); and providing the user with raters' feedback based evaluations—for example, in the form of: designations, ratings, labels, and/or tags—to his uploaded face depiction and/or attributes thereof.

A user module, in accordance with some embodiments, may include an Object Depiction Logic for utilizing one or more input components (e.g. camera, microphone, other sensors) of the User Computerized Device for acquiring the Object Depiction and for providing the User with tools for customizing the acquired Depiction prior to its uploading. Depiction customizing may, for example, include digital tools for cropping, resizing, applying filters and/or adjusting the brightness or contrast of an image depiction.

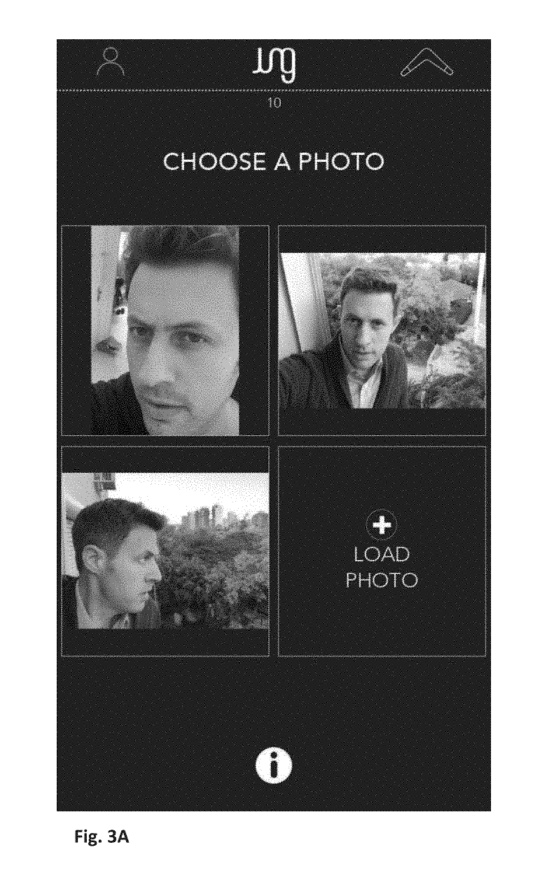

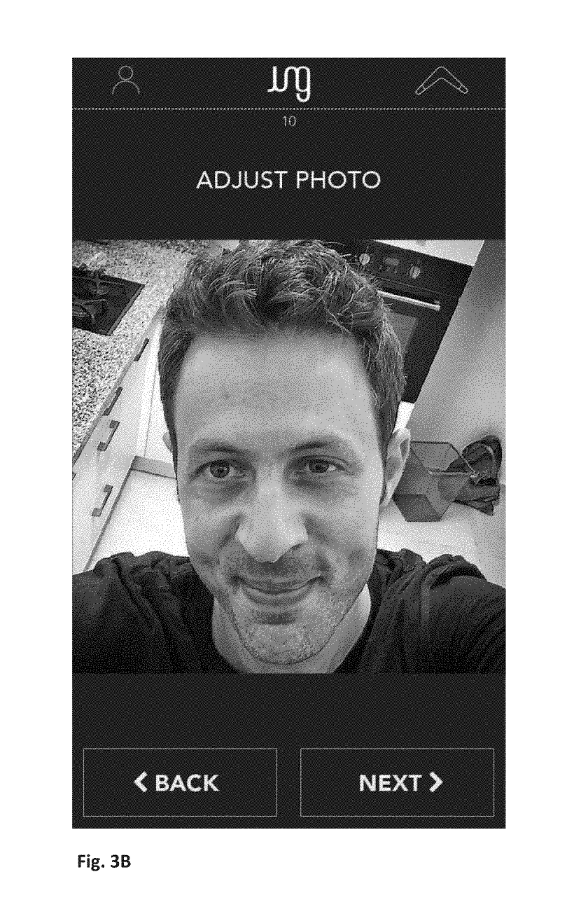

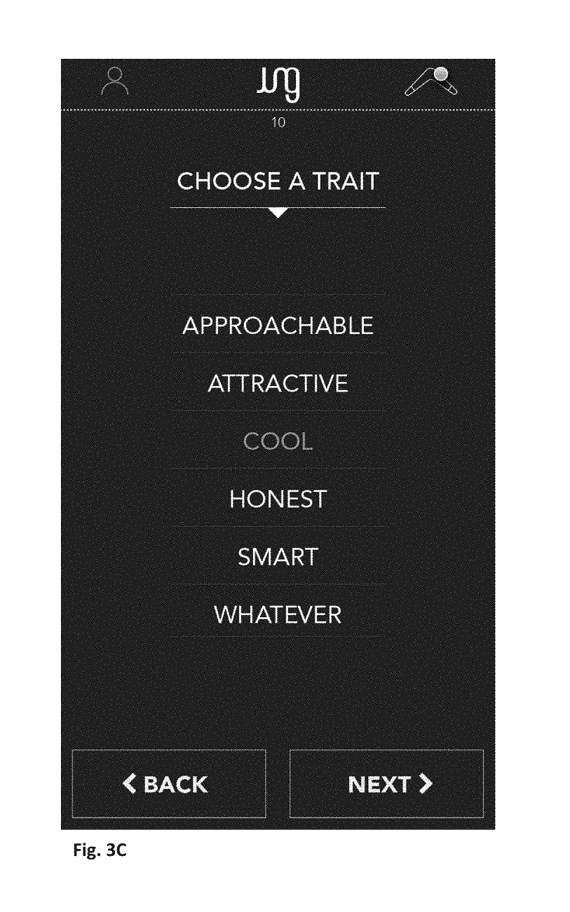

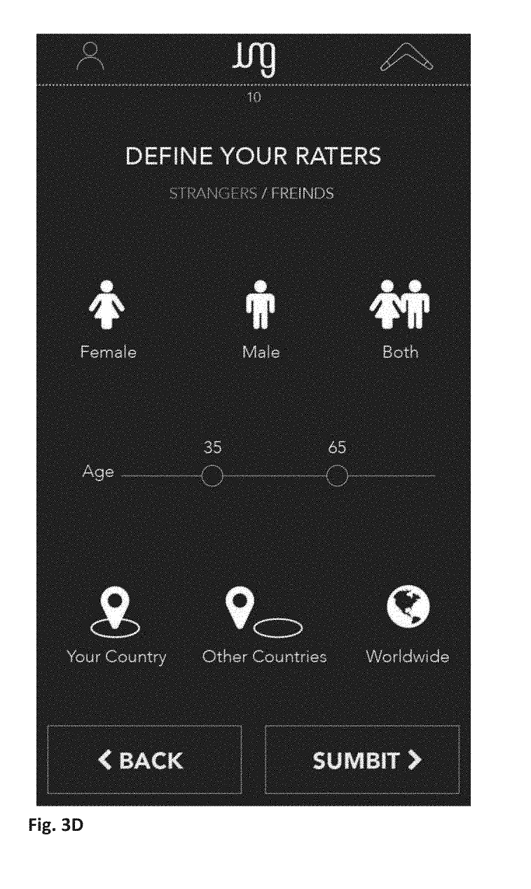

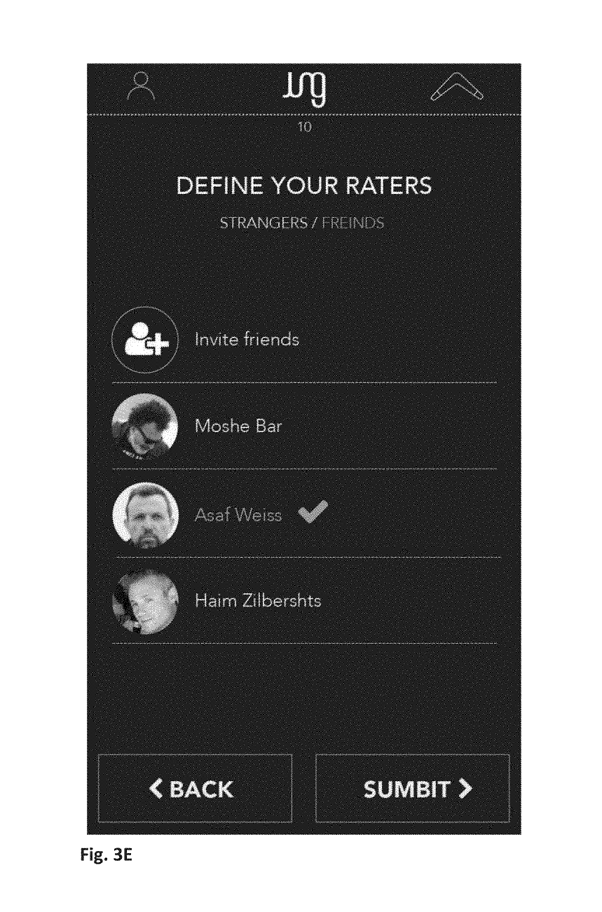

In FIG. 3A there is shown a screenshot of an exemplary object depiction logic interface of a user module/application. The interface allows for the user to select an object depiction by acquiring an image of the object, or by selecting a stored, previously acquired/received image of the object.

In FIG. 3B there is shown a screenshot of an exemplary object depiction logic interface of a user module/application. The interface allows for the user to customize an object depiction prior to its uploading to the server for dispatch to raters.

The operation/process of an Object Depiction Logic and the described system, in accordance with some embodiments, may be initiated by a user interested in an impression evaluation, of himself, of an object and/or of an environment; or, may be automatically triggered by the user module/application in response to another user device related action, for example, in response to: the acquisition or receipt of an image, the entering/exiting of a specific location, the restarting of the device, the unlocking of or the log—in of the device, the starting of another device installed application, or any combinations thereof.

Furthermore, the Object Depiction Logic and the described system operation/process may be initiated in response to a certain measurement of a physical parameter, or combination of physical parameters. For example, the system of the present invention may be functionally networked/connected to a wearable device used to measure one or more physical parameters of the wearing subject. Upon a measured physical parameter, or a combination of such, reaching or passing a threshold value, a notification may be communicated to the system of the present invention, which may, in response, initiate an impression evaluation process of the user. Accordingly, a depiction of the user may be automatically acquired and relayed for feedback, in accordance with any of the embodiments described herein. A physical parameter triggered evaluation, may be relayed to specific raters—for example, doctors or care takers—to receive their impression of the look/voice of the user whose measured physical parameters reached passed the threshold value(s) and may accordingly be suffering from a medical condition.

A user module, in accordance with some embodiments, may include an Attribute Selection Logic for receiving User chosen attribute(s), of the Object, for which impression evaluation is requested. User chosen attribute(s) may include: specific aspects or traits of the depicted object for which impression evaluation is aspired, for example, how attractive, cool, honest or smart—a person looks in a depiction; and/or specific parts, sections or items within the depiction, for which impression evaluation is aspired, for example, eyes of a depicted person, wheels of a depicted car or a dining table in a depicted home environment.

In FIG. 3C there is shown a screenshot of an exemplary attribute selection logic interface of a user module/application. The interface allows for the user to select attributes of an object depiction by presenting different aspects or traits relevant to the depicted object and receiving a user selection of one or more possibilities from within the provided options.

A user module, in accordance with some embodiments, may include a Rater Selection Logic for receiving User selection, profiling and/or segmentation definitions of the type of Raters and/or of specific Raters—from which the User would like to receive impression feedback to the Depicted Object or attributes thereof.

The selection of raters to which the object depiction will be relayed for feedback can be specific and/or condition/definition/profile based. As part of a specific rater selection, the rater selection logic may present to the user a listing of one or more specific raters to choose from. The listing may include: raters who are strangers to the user; and/or raters that have been previously associated with the user. Raters that have been previously associated with the user may include, either raters associated with the user as part of a community defined within the system, for example, from within raters previously selected by the user; or raters associated with the user as part of a community defined within another system or platform, for example, from within a social network's connections (e.g. Facebook friends), or a workplace network's connections.

In FIG. 3D there is shown a screenshot of an exemplary rater selection logic interface of a user module/application. The interface allows for the user to define a general profile of the type of raters from which he would like to receive feedback to his object depiction. In the example of the figure, the user is presented with tools for defining the gender, age and/or place of living—of the aspired raters.

In FIG. 3E there is shown a screenshot of an exemplary rater selection logic interface of a user module/application. The interface allows for the user to specifically define the raters from which he would like to receive feedback to his object depiction. In the example of the figure, the user is presented with a listing of either ‘friend’ or ‘stranger’ raters allowing for the selection of specific listed raters and/or for the invitation of additional, non-listed, ones.

A user module, in accordance with some embodiments, may include an Upload Logic for managing the communication of the: Object Depiction, user selected Object attributes and/or user selected Object raters, to the System Server.

Each customized object depiction may be associated and bundled, by the upload logic, with its respective user selected attributes and user selected raters. The consolidated information may than be relayed to the system server.

A System Server, in accordance with some embodiments, may manage the receipt and processing of object depictions uploaded by users, their communication to selected raters or rater groups, the analysis of raters provided object depiction feedbacks and/or the relaying of raters' feedbacks based impression evaluation—back to the initiating users—for presentation on their device.

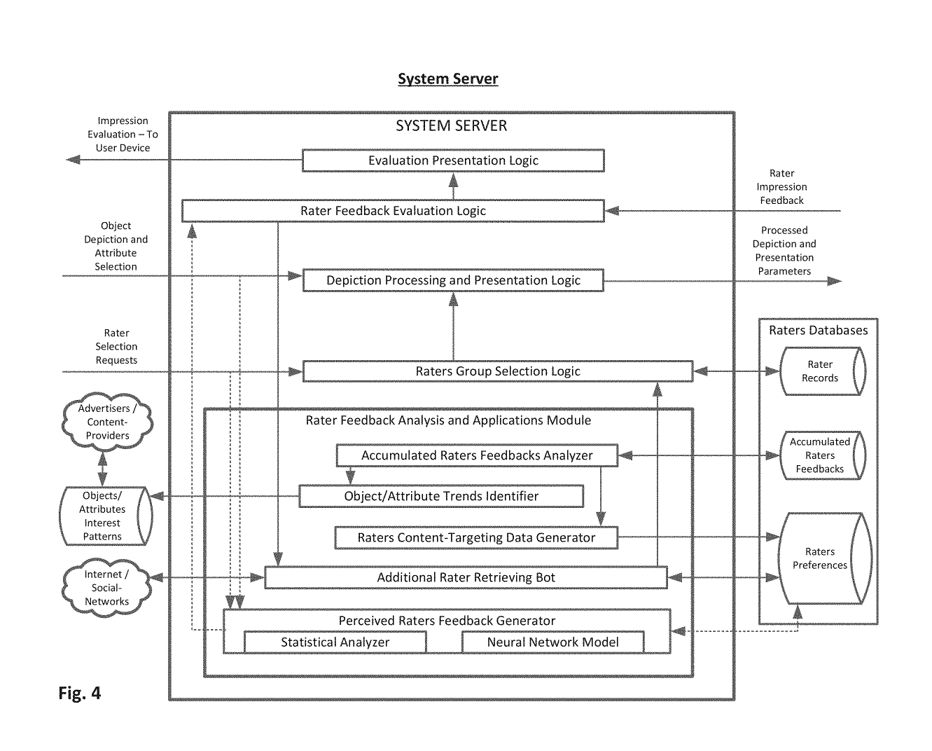

In FIG. 4 there are shown in further detail, in accordance with some embodiments, the main components and component relationships of an exemplary system server. The shown system server is communicatively associated with a user device/module and with one or more rater devices/modules.

The shown system server includes a raters group selection logic for analyzing communicated user selection requests, of profiling and/or segmentation definitions of raters and, for referencing the shown rater records database and determining the specific group of raters associated computerized devices to which the object depiction will be communicated/dispatched/multicasted for feedback.

The shown system server further includes a depiction processing and presentation logic for receiving the object depiction and attribute selection; determining the schemes, characteristics and/or parameters to be associated with the presentation of the object depiction and relaying them to the specific group of raters associated computerized devices determined/selected.

The shown system server further includes a rater feedback evaluation logic for processing the raters' impression feedback data (or perceived impression feedback data) and generating one or more impression parameters based thereof. Generated impression parameters are relayed to the evaluation presentation logic for communication to the user. If insufficient amount of rater feedback is available, the shown additional rater retrieving bot is notified.

The shown system server further includes an evaluation presentation logic for selecting a rater's evaluation presentation scheme, customizing it based on the impression parameters generated for the current evaluation, and generating and relaying the associated presentation/rendering parameters to the user computerized device from which the object depiction was originally uploaded.

The shown system server further includes a rater feedback analysis and applications module for processing and analyzing system collected raters' feedbacks and facilitating applications based thereof. rater feedback processing, analysis and application components shown, include: an accumulated raters feedbacks analyzer to determine the preferences of specific raters and/or specific rater groups/segments by referencing the accumulated raters feedbacks database shown; a raters content-targeting data generator for receiving analyzed raters feedback data, generating system raters associated content targeting data and storing it in the shown raters preferences database; an object/attribute trends identifier for receiving analyzed raters feedback data, identifying general object/attribute related trends, and storing identified trends in the shown objects/attributes interest patterns database accessible by advertisers and content-providers; a perceived raters feedback generator, including a statistical analyzer and a neural network model, for providing perceived rater feedbacks based on the statistical analysis of stored information from previous ratings in the shown raters preferences database and/or the neural model after it was trained with accumulated actual human ratings; and an additional rater retrieving bot, communicatively connected to an internet gateway, for identifying and inviting potentially relevant raters based on notifications form the raters feedback evaluation logic rater groups for which it seeks additional raters.

A system server, in accordance with some embodiments, may include a Raters Group Selection Logic for analyzing communicated User selection, profiling and/or segmentation definitions of raters and, for determining, at least partially based the analysis results, the specific group of Raters associated Computerized Devices to which the Object Depiction will be communicated/dispatched/multicasted for feedback.

According to some embodiments, the group selection logic may reference a raters database with queries generated based on rater-selection related definitions received from users. The generated queries may, for example, include: selection of raters from the database based on user uploaded rater-identifiers (e.g. names, device code/token, aliases, application associated identification number), wherein a record search of the database is performed at least partially based on the available rater-identifier(s); and/or selection of raters satisfying one or more conditions of the query, such as raters within a user selected age range, of a specific gender, of specific place(s) of living or residence and/or the like.

According to some embodiments, the group selection logic may apply one or more methodologies and/or algorithms for determining the raters to which the object depiction will be communicated. According to some embodiments, applied algorithms may for example, include:

A Standard Deviation based algorithm, wherein: (a) the object depiction is communicated to a first set of raters (e.g. randomly selected, randomly selected from within a defined group); (b) feedback data, from communicated group, is collected; (c) standard deviation is calculated for the values (e.g. impression parameters/ratings) collected; (d) calculated SD is compared to a predetermined SD threshold value; and/or (e) if the calculated value falls below the threshold value (i.e. the impression parameter reflects a general rater consensus) the process is terminated and the evaluation is forwarded to the user; else, the object depiction is communicated to a second/next set of raters and steps (b)-(e) are repeated.

A Statistical Tool based algorithm, wherein the object depiction is communicated to a minimal number of raters that would provide a minimal number of impression parameters collectively satisfying a statistical/distributional value, range or condition.

And/or, an Asymptote Behavior based algorithm, wherein the object depiction is communicated to a growing number of raters; and, impression parameters based on the received rater feedbacks are simultaneously or intermittently calculated, until an asymptote behavior of the ongoing calculated result is achieved/identified.

A system server, in accordance with some embodiments, may include a Depiction Processing and Presentation Logic for determining the schemes, characteristics and/or parameters associated with the presentation of the Object Depiction over the specific group of Raters associated Computerized Devices determined/selected. According to some embodiments, Object Depiction presentation schemes, characteristics and/or parameters, may include or relate to, any combination of the following:

Time length, or limited time length, based presentation of the Object Depiction to the communicated rater(s), wherein: (a) the presentation time is at least partially dependent on the type and/or number of object attribute(s) for rating, selected by the user; for example, a larger number of attributes for evaluation, or more detailed/complex attributes requiring more rater assessment time, are presented to the rater for a longer time period; (b) the presentation time is different for individual raters, dependent on the result of an initialization phase; for example, an identical or similar depiction (e.g. dummy, placebo), or a set of such, is initially presented, the time it took each rater to rate is logged and the actual user uploaded depiction is presented to each given rater for a time period which is based-on/proportional-to the same rater's logged speed of rating(s) during initiation phase; and/or (c) the depiction is presented for a first (e.g. short) limited time period/span, presentation is then halted and an additional second limited time period/span, is given to the rater for providing his feedback/ratings, after which rating ability is disabled; for example, the depiction is presented for under 100 milliseconds and then removed, followed by presentation of a raters' rating screen for 5 seconds or longer.

A presentation scheme, wherein the size (i.e. file/data size/amount, e.g. number of bytes), resolution and/or quality level of the Object Depiction version communicated and presented to the rater(s)—is lowered or degraded prior to its communication; for example, a depiction image that is 2048 pixels wide and 1536 pixels high is degraded to a 1024 pixels wide and 768 pixels high image. Lowered or degraded depictions may be distributed between raters in a shorter time, due to the smaller amounts of data they contain and/or may, when presented for substantially short periods of time, direct the focus of their viewer to focus on the main features they include, as more minor or less detailed features become harder to identify.

A presentation scheme, wherein a distraction filter is initially applied to the depicted image, for optimizing the presentation to minimize unwanted distractions affecting Rater's impression of the depicted object. Unwanted distractions may be identified in the image based on their position within the frame, their shape, their color, their texture and/or based on other characteristics thereof, all of which characteristics may be provided by the user and/or extracted from accumulated system knowledge. For example, the depiction for an impression evaluation of sunglasses having blue lenses which are being worn by a person, may be graphically treated to enhance blue shades/colors while fading out other shades/colors (e.g. red and blue).

A presentation scheme, including the application of one or more skew preventing techniques, for preventing, moderating and/or minimizing or eliminating biased/tilted ratings. Skew techniques may, for example, include: (a) the separation of object depictions requesting ratings of identical or similar attributes; for example, a sunglasses rating request is presented to a given rater, a consecutive following rating request for sunglasses, to be presented to the same given rater, is relayed to a different rater instead and/or its presentation to the given rater is delayed until another—non sunglasses related—depiction has been presented to and rated by him; (b) An initial set of ratings made by a given rater are discarded and following ratings are then kept and used for evaluation; for example, the first three depiction ratings of a given rater's rating session are automatically discarded from or disregarded—as part of the impression evaluation; (c) An initial set of the rater with an initial set of ‘dummy’/placebo depictions before actual depictions, uploaded by real users, are presented for his rating; (d) Presenting a limited number (e.g. a single) of attributes/characteristics, of the same specific object depiction, to a same given rater; for example, an object depiction of a person, requesting an evaluation of how: nice, cool, handsome and young the depicted person is, may initially be relayed to a first rater—for niceness and coolness impression—but then, relayed to a second rater—for handsomeness and youngness impression.

A Rater Module, in accordance with some embodiments, may include any combination of electric circuitry and/or computer executable code and may be installed onto and/or integrated into the Rater Computerized Device.

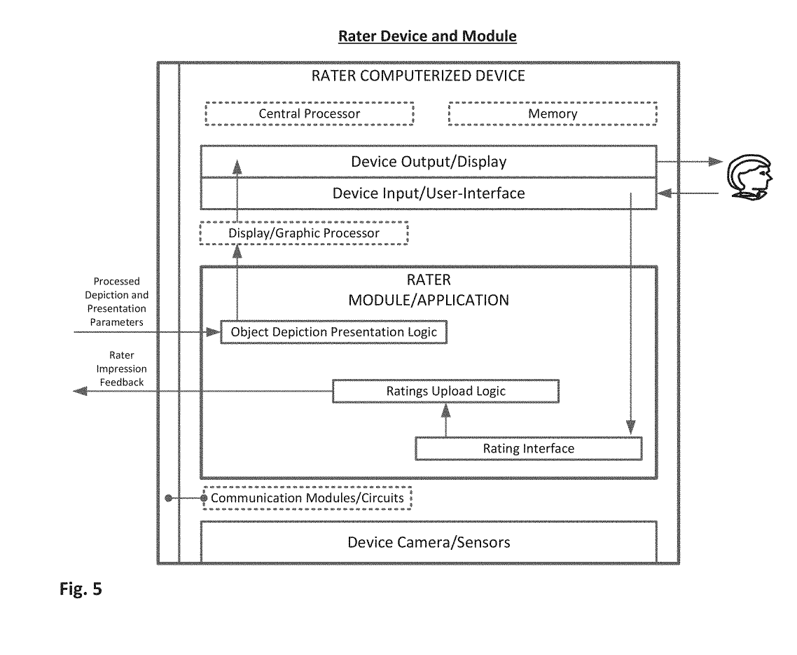

In FIG. 5 there are shown in further detail, in accordance with some embodiments, the main components and component relationships of an exemplary rater module.

The shown rater module is installed onto or integrated into a rater computerized device. The shown device comprises at least a central processor, a memory, a graphic processor and communication circuitry. the shown rater module includes: an object depiction presentation logic for receiving a processed depiction and presentation parameters thereof and, for utilizing one or more output components (e.g. display, speaker, other) of the rater computerized device for presenting the depiction for rater assessment and feedback; a rating interface for presenting the rater with rating tools, receiving his feedback inputs and relaying it to the shown ratings upload logic for managing the communication of the feedback to the system server.

A rater module, in accordance with some embodiments, may include an Object Depiction Presentation Logic for utilizing one or more output components (e.g. display, speaker, other) of the Rater Computerized Device for presenting the Depiction for Rater assessment and feedback.

The object depiction may be presented in accordance with any combination of presentation rules/schemes applied by the system server's Depiction Processing and Presentation Logic. The rules/schemes applied by the system server's Depiction Processing and Presentation Logic may be selected based on: (a) selections made by the evaluation requesting user; (b) logged rating performance of specific raters or sets thereof, from within the raters selected for providing evaluation feedback; (c) the amount or number of raters selected/requested for performing the evaluation; and/or (d) the type or number of object attributes for evaluation selected for the depiction.

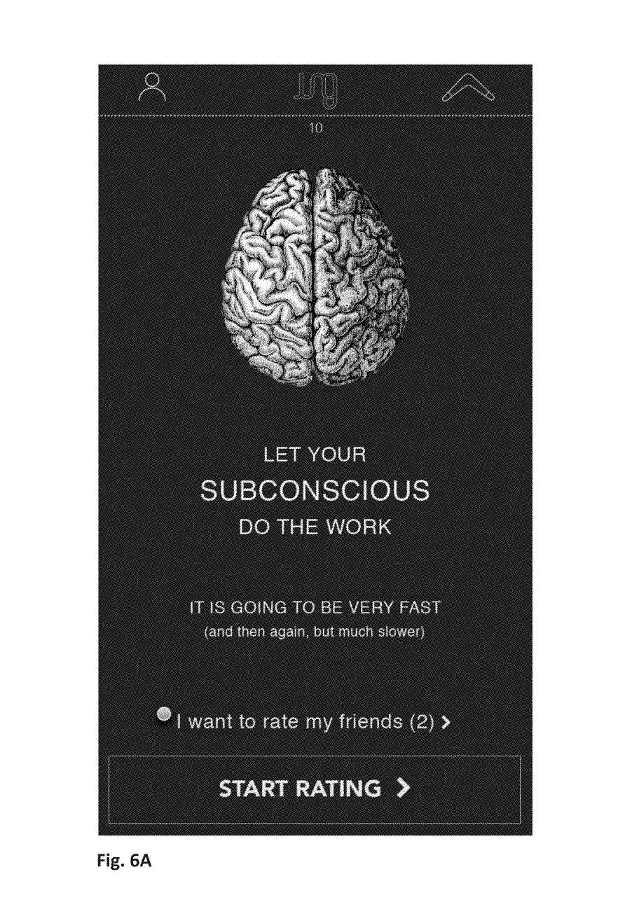

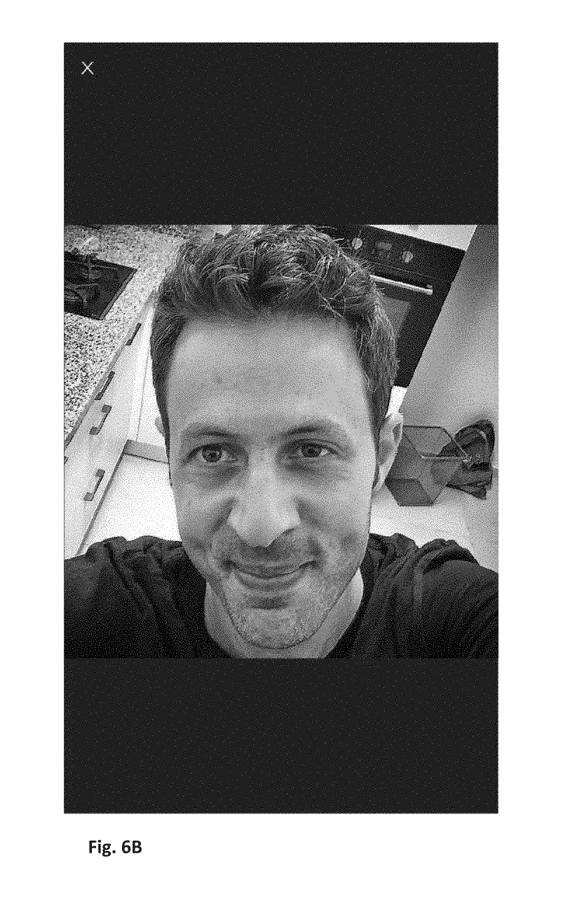

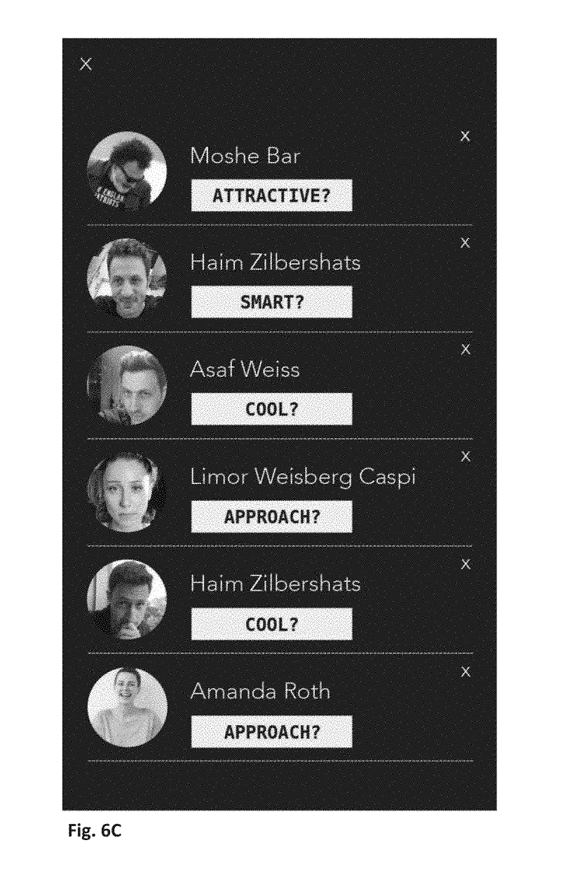

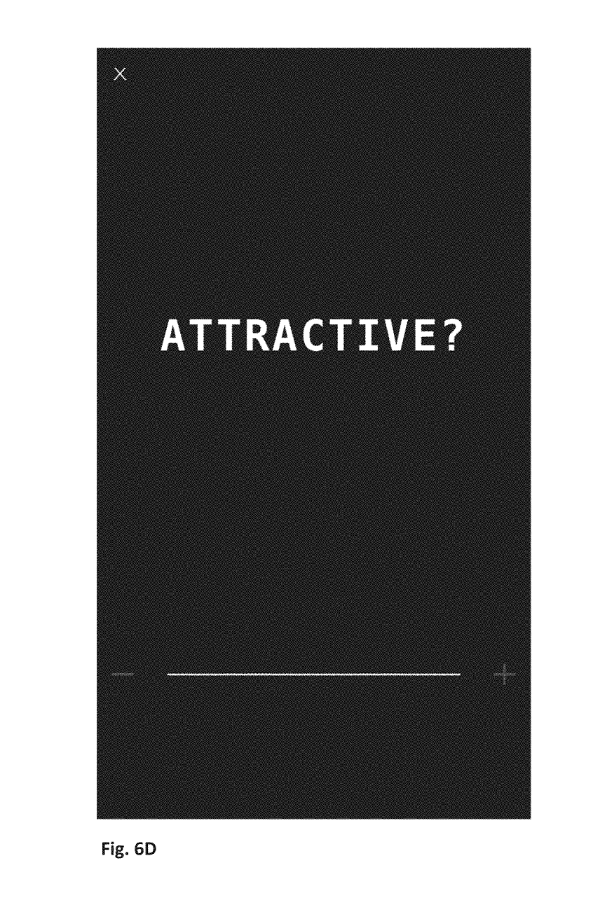

In FIG. 6A there is shown a screenshot of an exemplary object depiction presentation logic interface of a rater module/application. The interface prepares the rater for a shortly timed presentation of an object depiction for his feedback/rating. The interface further include an ‘I want to rate my friends’ button, for allowing the rater to rate/provide-feedback-to evaluation requests made by other system users associated with—for example, system community or social network friends.

In FIG. 6B there is shown a screenshot of an exemplary object depiction presentation logic interface of a rater module/application, presenting to the rater, optionally for a limited time period, the object depiction for which his feedback is requested.

In FIG. 6C there is shown a screenshot of an exemplary object depiction presentation logic interface of a rater module/application, presenting to the rater a listing of requests from system community or social network friends, pending his rating/feedback.

A rater module, in accordance with some embodiments, may include a Rating Interface for presenting the rater with rating tools and receiving his feedback inputs. Rating tools may include any machine interface type, or graphic interface element, known today, or to be devised in the future, including but not limited to, any combination of: a knob, a button, a direct point and click selector, an optical machine interface, a vocal machine interface, a radio frequency based machine interface and/or other(s).

In FIG. 6D there is shown a screenshot of an exemplary rating interface of a rater module/application, allowing the rater to feedback on the attractiveness of an object in a depiction which was/is-being presented to him, wherein a graphic knob element may be moved horizontally—to the right, in order to increase the attractiveness level perception experienced by the rater; or to the left, in order to decrease the attractiveness level perception experienced by the rater.

A rater module, in accordance with some embodiments, may include a Ratings Upload Logic for managing the communication of the rater's feedback back to the system server for evaluation, analysis and/or relaying for presentation to the evaluation requesting user.

A system server, in accordance with some embodiments, may further include a Rater Feedback Evaluation Logic for processing the Raters' feedback data and generating one or more Impression Parameters, based on which an impression evaluation will be presented to the requesting user. According to some embodiments, generated impression parameters may include any combination of the following:

Impression parameters based directly on the received rater's feedback rating(s), for example: (a) a rater's score value selection, for example a whole number between 1 and 5; (b) a rater's negative-positive score value selection, for example a whole number between −5 and 5; and/or (3) a rater's binary score value selection, for example ‘Like’ or ‘Dislike’.

Impression parameters at least partially based on secondary information such as the characteristics of the rater's response execution, for example: (a) the level of engagement (pressure/force applied) with the rater device's interface on the rater's response, for example, the amount of pressure or force applied to the touch screen of the device as part of raters feedback input, wherein more pressure/force may indicate higher engagement level; and/or (b) the length of time taken for the rater to respond/provide-feedback, wherein a longer time period may indicate a higher level of engagement or a higher matching level between the rater and the evaluated object depiction and/or attributes thereof.

A combined impression parameters calculation, based on a combination of received rater's feedback rating(s) and secondary information. A combined impression parameters calculation may accordingly take into account any combination of: an initial rater's rating value of the current object depiction, the response time it took the rater to provide the current feedback, the average time it usually takes the same rater to provide feedback (based on his past object depictions' ratings), the response pressure applied by the rater to provide the current feedback and/or the average response pressure usually applied by the same rater when providing feedback (based on his past object depictions' ratings).

An exemplary combined impression parameters calculation, in accordance with some embodiments, may be based on an initial rater rating; to which, the product of the multiplication of: (a) the quotient of the average response time by the current response time, by (b) the quotient of the current response pressure by the average response pressure, is added. For example: Impression Parameter=initial rater rating+((average response time/current response time)*(current response pressure/average response pressure)).

According to some embodiments, an exemplary formula that may be used to calculate an impression parameter of a specific rater's rating, which may be dynamic and may, for example, be measured in units termed Bar Measure (BMs) may be:

$$R = r + [ ( \frac{\overline{s}}{s} ) * ( \frac{p}{\overline{p}} ) ]$$

### Where:

R—is the impression parameter being calculated.
r—is the raw rater's rating (e.g. min to max).
p—is the amount of pressure applied by the rater in the current response.
p̅—is the average amount of pressure applied by the rater.
s—is the rater's response time or rate of quickness in the current response.
s̅—is the average response time or rate of quickness it takes the rater to respond.
A rating parameter barred based thereof, in accordance with some embodiments, may be based on an average of that resulting parameter (R in the formula) for a specific rater over time, based on all his responses.

According to some embodiments, an exemplary combined impression parameters calculation or formula, as described herein, may consider measured values of a physical parameter, or combination of physical parameters, of feedback providing raters. For example, the system of the present invention may be functionally networked/connected to a wearable device used to measure one or more physical parameters of the wearing rater. The measured physical parameters, or a combination/derivation of such, may be added into the calculation and may thus affect the resulting rater feedback or rating. Physiological measures and/or physiological parameters of raters providing the feedback, may include, but are not limited to: heart rate, pupil diameter and eye movements, vocal responses, blood pressure, skin conductivity and/or others.

Impression parameters calculated as a moving average of any of the impression parameters described herein—for a specific rater, or set of raters, over time, based on his/her/their accumulating responses/ratings to the time of calculation.

And/or, impression parameters of combined raters' group perception of object/attributes based on feedback signals received from a plurality of raters and calculation of group indicative impression parameters, for example, based on a statistical index calculated for the plurality of raters feedbacks received. A combined raters' group perception indicative value, in accordance with some embodiments, may for example be calculated, as: (a) an average between the ratings of participating raters; and/or (b) a weighted average based on system accumulated knowledge about specific raters and their preferences and relevance to the current object depiction being rated.

A system server, in accordance with some embodiments, may further include an Evaluation Presentation Logic for selecting a rater's evaluation presentation scheme; customizing it based on the impression parameters generated for the current evaluation; and/or generating and relaying the associated presentation/rendering parameters to the user computerized device from which the object depiction was originally uploaded.

According to some embodiments, the user of the computerized device may share a received impression evaluation with one or more other users or raters of the system community, within predefined groups thereof and/or with connections/friends through other platforms/social-networks. For example, a diamond dealer that received a positive impression evaluation for a diamond in his stock, may share the evaluation with his associate dealers to help him find a buyer for the positively evaluated stone.

According to some embodiments, the rater's evaluation presentation scheme and its customizing may be based on: system rules and settings, user settings/preferences and/or rater settings/preferences.

A rater evaluation, in accordance with some embodiments, may be presented to the user as an average, or other statistical index, between the ratings of the users participating in the rating of that specific object depiction rating.

A rater evaluation, in accordance with some embodiments, may be presented to the user as a weighted average based on system accumulated knowledge about specific raters and their preferences—and based thereof, about their level of relevance to the current evaluation. For example, a rater that often chose to rate object depictions associated with eye-glasses and/or presented a specific rating pattern for eye-glasses including object depictions (e.g. higher than average ratings) may be considered more relevant to eye-glasses or eyewear—and thus, his ratings of eye-glasses/eyewear including object depictions may be allocated a higher weight than that of a counterpart who is not ‘fond’ of eyewear.

A rater evaluation, in accordance with some embodiments, may be presented to the user as a breakdown of the participating raters target group to multiple rater sub-groups/segments/clusters, each with a respective calculated average, weighted-average and/or other statistical index. For example, system provided raters' ages, may be utilized to divide the participating raters' group of a given object depiction evaluation, to multiple age-range groups (e.g. 20-30, 30-40 and 40-50 years old) and present to the user in a breakdown/segmented format.

A rater evaluation, in accordance with some embodiments, may be presented to the user as an asynchronous or a multi-evaluation/evolving-evaluation presentation, wherein the relaying for user presentation of an initially generated impression parameters based evaluation, may be delayed until a threshold number/amount/quality of raters' feedbacks is received by the system. The evaluation may be executed and presented based on partial feedback data available, optionally followed by the relying and presentation of updated impression parameters based evaluations, as further feedback data is received by the system and further/updated impression Parameters are generated. According to some embodiments, notifications indicating a delay-in/time-to evaluation presentation, or an ‘Initial/Partial-Data-Based Evaluation’ message, may be generated and respectively relayed and presented to the associated user(s). Delay associated notifications may be triggered based upon notifications from the rater feedback evaluation logic of corresponding rater feedback receipt timeouts.

A user module, in accordance with some embodiments, may further include a User Device Evaluation Presentation Logic for utilizing one or more output components (e.g. display, speaker, other) of the user computerized device for presenting the raters' evaluation results for the requested object depiction and/or attributes to the user. The User Device Evaluation Presentation Logic, as part of the presentation of the evaluation, may apply one or more rules, schemes and/or presentation or rendering instructions/parameters, provided by the Evaluation Presentation Logic of the system server.

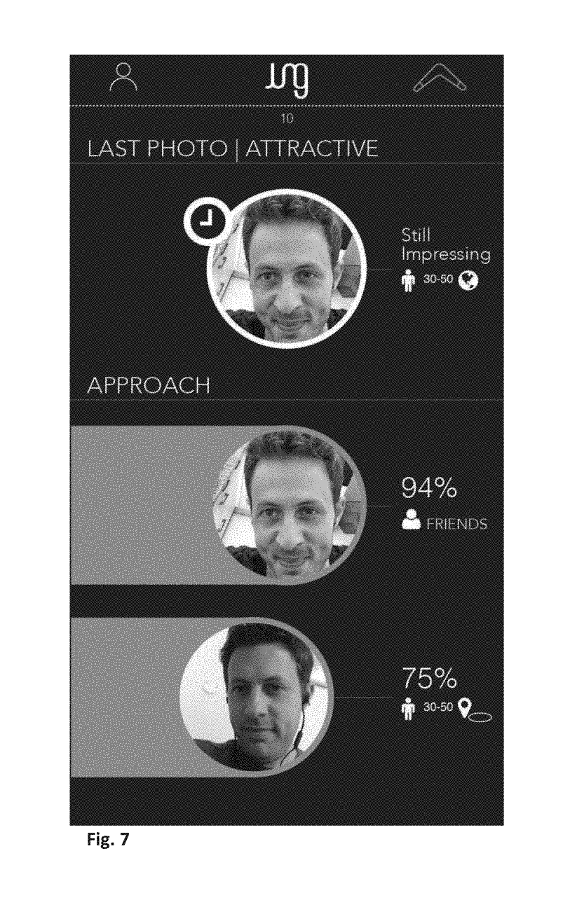

In FIG. 7 there is shown a screenshot of an exemplary feedback impression results presentation of a user module/application. The exemplary impression results show the last depiction made by the user (a photo of himself) to be regarded as ‘still impressing’ when rated for attractiveness by raters between the ages of 30 and 50 from all around the world (globe icon). Ratings of how approachable the user is (based on his depictions) include: a rating of a first depiction, made by friends of the user—wherein 94% of the raters regarded him as approachable, or wherein a 94% approachability level was calculated; and a rating of a second (bottom) depiction, made by raters between the ages of 30 and 50 from outside the user's country—wherein 75% of the raters regarded him as approachable, or wherein a 75% approachability level was calculated.

A user module, in accordance with some embodiments, may further include a User Recognition Feedback Logic. The user recognition feedback logic may automatically trigger the acquisition of an object depiction and its relaying for rater feedback. According to some embodiments, a portrait/face image acquired/utilized as part of a user face recognition process (e.g. at user's mobile device unlocking/login) may be relayed for generating an impression evaluation based on raters' feedback. The automatic evaluation process may, for example, be triggered by one or more software (e.g. boot device), firmware (e.g. bios) and/or hardware components, of the user computerized device or user module, which are initiated or auto-executed as part of a start-up, restart, login and/or unlocking process of the device. The initiated component(s) may, upon their initiation, notify the user recognition feedback logic of the system user module, to begin an impression evaluation process, in accordance with any of the embodiments described herein.

Raters for the automatically triggered evaluation may be automatically selected by the system and/or may be at least partially predefined by the user of the device/module/application. Accordingly, a given user may intermittently and automatically receive feedback relating to his look and the impression it makes, when starting or logging-into his computerized device (e.g. smartphone). According to some embodiments, the user recognition feedback logic may be adapted to trigger an automatic user evaluation in response to actions other than the startup or login of their computerized device, for example, an automatic user evaluation process may triggered in response to the user mobile device: acquiring a picture or a video, entering or exiting a designated area, reaching a specific time(s) of the day, completing an online purchase or registration and/or any other computerized device associated action or occurrence/event.

Automatically provided rater evaluations, in accordance with some embodiments, may for example, take the form of: designations, ratings, labels, and/or tags—to the user's auto uploaded face depiction and/or to certain attributes thereof. Automatically provided rater evaluations may include designations in regard to raters' preferred, liked, disliked and/or commented-to user-depictions; and/or may relate/compare to prior automatically provided rater evaluations of the same user. For example, the message: ‘John/Jane, today you look better than yesterday’ may be presented to a user whose current automatically provided rater evaluation for attractiveness, received better evaluation ratings than a similar automatic evaluation made the day before.

A system server, in accordance with some embodiments, may further include a Rater Feedback Analysis and Applications Module for processing and analyzing system collected raters' feedbacks and facilitating applications based thereof. Rater feedback processing, analysis and application, in accordance with some embodiments, may, for example, include any combination of the following:

According to some embodiments, accumulated feedback of specific raters may be analyzed to determine the preferences of specific raters and/or specific rater groups/segments. Rater preferences may be stored in respective rater-associated database records and may be utilized by the system to direct user-uploaded object depictions to raters or rater groups matching, preferring, or interested-in, the depicted object or specific attributes thereof, thereby increasing the likelihood of more accurate, honest and/or positive rater feedbacks.

According to some embodiments, based on their ‘preference history’ as expressed in their accumulated feedbacks, content targeting data for system raters may be generated. Generated targeting data may be utilized for matching content to system raters. Content targeting data may be: (a) utilized internally within the system, for example, for directing interest-matching object depictions to specific raters, selecting in-app advertisements for presentation within the rater application and/or for better matching of system/application features/deal-offerings to raters; and/or (b) utilized externally or offered to 3rd parties, for external user targeted advertising, promotion and/or campaigns.

According to some embodiments, rating characteristics within multiple ratings of depictions of specific objects/attributes may be monitored and collectively analyzed to identify and reveal various trends and patterns—of general interest and/or of interest within specific audience segments based on corresponding raters groups—associated with the specific objects/attributes.

According to some embodiments, perceived rater feedbacks may be calculated and provided (i.e. without receiving further human ratings). Perceived rater feedbacks may, for example, be based on the statistical analysis of stored information from previous ratings, wherein accumulated ratings of specific objects or attributes may be used to estimate the feedbacks that will be received in a following rating of the same objects or attributes; accumulated ratings of specific objects or attributes made by specifically profiled groups of raters may be used to estimate the feedbacks that will be received in a following rating of the same objects or attributes by a substantially similarly profiled group of raters.

According to some embodiments, perceived rater feedbacks may, for example, be based on the building and application of a neural network model—trained with sets of object/attribute depictions and their respective actual human raters' ratings—to later generate perceived rater feedbacks for newly received object/attribute depictions.

According to some embodiments, the neural network model may be trained by supervised learning, wherein training data object/attribute depictions are fed to the model along with respective ‘correct’ rater feedback—made by actual human raters. According to some embodiments, multiple neural network models, pertaining to specific objects/attributes may be trained with ‘correct’ rater feedback—made by actual human raters to objects/attributes similar to those of the specific objects/attributes.

According to some embodiments, any other Artificial Intelligence (AI) and/or deep learning techniques or computational models, know today or to be devised in the future, may be utilized for generating perceived rater evaluation, at least partially based on accumulated real human-raters feedbacks.

According to some embodiments, an Internet bot may be applied for identifying and inviting potentially relevant raters based on system-determined rater groups for which it seeks additional raters. The Internet bot may be provided with a profile of the rater group(s) for which additional raters are sought, the bot may approach potential raters matching the provided profile over Internet websites, over social networks, within the user bases of specific web or mobile applications and/or from within system raters who are not currently logged into the application, but may be accessible online elsewhere.

According to some embodiments of the present invention, a system for impression measurement and evaluation, may comprise: a user module installed or integrated into a user device for acquiring an object depiction, receiving user definitions for the selection of one or more raters for providing feedback to the object depiction and for uploading the acquired depiction and the rater definitions to a system server; the system server for referencing a database containing records of candidate raters and retrieving identity details of one or more rater devices associated with candidate rater details matching the received user definitions; for selecting a depiction presentation scheme, wherein the presentation scheme includes at least a first time span for defining the time length of presentation of the depiction to raters and a second time span for defining the time length given to raters in order for them to provide feedback for to the object depiction; and for communicating the object depiction and the presentation scheme selected for it, to the rater devices which details were retrieved; One or more rater modules, installed or integrated into at least the rater devices for which identity details were retrieved, for receiving the object depiction and the presentation scheme selected for it from the system server, presenting the received object depiction and a rater feedback interface in accordance with the first and the second timespans, respectfully; and communicating rater feedbacks to the object depiction, where provided, to the system server; the system server, for receiving multiple rater feedbacks to the object depiction, where provided, form the rater modules, for generating one or more joint impression parameters based on the received multiple feedbacks; and for communicating the joint impression parameters to the user module; and, the user module for presenting to the user an object impression evaluation for the uploaded object depiction, wherein the object impression evaluation at least partially includes, or is at least partially based on, the joint impression parameters.

According to some embodiments, the user module may further includes an attribute selection logic for receiving a designation of one or more attributes of the acquired object depiction, for rater evaluation.

According to some embodiments, the attribute selection logic may present to the user a predefined set of two or more optional object depiction attributes to choose and designate from.

According to some embodiments, the system server may be further adapted to process the acquired object depiction to highlight one or more of the object attributes designated by the user.

According to some embodiments, the object depiction may include an image, wherein highlighting user designated attributes at least partially includes degradation of the depiction image or parts thereof, prior to its communication to raters, to emphasize the designated attributes.

According to some embodiments, receiving user definitions for the selection of one or more raters may include presenting for user selection at least a rater's age constraint interface element, a rater's place of residence constraint interface element or a rater's gender constraint interface element.

According to some embodiments, the depiction presentation scheme may include instructions for presentation of a rater notification preparing the rater to the presentation of the object depiction, wherein the notification is presented to the rater just prior to the beginning of the first time span.

According to some embodiments, the first time span may be shorter than 5 seconds.

According to some embodiments, the depiction presentation scheme may include instructions for presentation of an initial set of placebo object depictions for rater's rating, prior to the presentation of the actual user uploaded object depiction for his rating.

According to some embodiments, generating the joint impression parameters may be based on the received multiple feedbacks and may include allocating different weights to at least some of the associated raters' feedbacks based on the rating history of their respective raters.

According to some embodiments, generating the joint impression parameters may at least partially include a calculation of combined rater-specific impression parameters, while taking into account a combination of: an initial rater's rating value for the current object depiction, the response time it took the rater to provide the current feedback and the response pressure applied by the rater as part of providing the current feedback.

According to some embodiments, the calculation of combined rater-specific impression parameters may further include taking into account an average response pressure applied by the current rater or an average response time taken by the current rater.

According to some embodiments, the system server may include an Internet bot applied for inviting potentially relevant raters to rate a specific object depiction for which the system determined that additional raters are needed.

According to some embodiments, the system server may determine that additional raters are needed for the rating of the specific object depiction, based on the accumulated rater-specific impression parameters not reaching or passing a statistical threshold value, or not showing an asymptotic behavior—once a certain predetermined number of ratings have been received.

According to some embodiments, the system server may be adapted to generate perceived object depiction ratings without human intervention, at least partially based on logged raters' feedback history pertaining to prior object depictions.

According to some embodiments, logged raters' feedback history may be statistically analyzed for generating perceived object depiction ratings.

According to some embodiments, the system may further include a neural network model, wherein logged raters' feedback history is used as training data for the neural network model and once trained the model is utilized for generating perceived object depiction ratings.

According to some embodiments of the present invention, a method for impression measurement and evaluation may comprise: receiving from a user device an acquired object depiction; receiving from the device user definitions for the selection of one or more raters for providing feedback to the object depiction; referencing a database containing records of candidate raters and retrieving identity details of one or more rater devices associated with candidate rater details matching the received user definitions; selecting a depiction presentation scheme, wherein the presentation scheme includes at least a first time span for defining the time length of presentation of the depiction to raters and a second time span for defining the time length given to raters in order for them to provide feedback for to the object depiction; presenting the received object depiction and a rater feedback interface over the one or more rater devices for which device identities were retrieved, in accordance with the first and the second timespans, respectfully; receiving multiple rater feedbacks to the object depiction; generating one or more joint impression parameters based on the received multiple feedbacks; and presenting over the user device an object impression evaluation for the uploaded object depiction, wherein the object impression evaluation at least partially includes, or is at least partially based on, the joint impression parameters.

According to some embodiments of the present invention, a mobile computerized communication device may include: a face recognition device login system. And, a system for impression measurement and evaluation, including: a user module installed or integrated into the mobile computerized communication device for uploading an object depiction to a system server; the system server for referencing a database containing records of candidate raters and retrieving identity details of one or more rater devices and for selecting a depiction presentation scheme, wherein the presentation scheme includes at least a first time span for defining the time length of presentation of the depiction to raters and a second time span for defining the time length given to raters in order for them to provide feedback for to the object depiction; and for communicating the object depiction and the presentation scheme selected for it, to the rater devices which details were retrieved; one or more rater modules, installed or integrated into at least the rater devices for which identity details were retrieved, for receiving the object depiction and the presentation scheme selected for it from the system server, presenting the received object depiction and a rater feedback interface in accordance with the first and the second timespans, respectfully; and communicating rater feedbacks to the object depiction, where provided, to the system server; the system server, for receiving multiple rater feedbacks to the object depiction, where provided, form the rater modules, for generating one or more joint impression parameters based on the received multiple feedbacks; and for communicating the joint impression parameters to the user module; and the user module for presenting to the user an object impression evaluation for the uploaded object depiction, wherein the object impression evaluation at least partially includes, or is at least partially based on, the joint impression parameters. And, wherein the system for impression measurement and evaluation has access to images acquired, as part of a user device login process executed by the face recognition device login system; and is adapted for automatically uploading images acquired by the face recognition device login system, as object depictions for impression measurement and evaluation.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for impression measurement and evaluation, said system comprising:
a user module installed or integrated into a user device for acquiring an object depiction, receiving user definitions for the selection of one or more raters for providing feedback to the object depiction and for uploading the acquired depiction and the rater definitions to a system server;
said system server for referencing a database containing records of candidate raters and retrieving identity details of one or more rater devices associated with candidate rater details matching the received user definitions; for selecting a depiction presentation scheme, wherein the presentation scheme includes at least a first time span for defining the time length of presentation of the depiction to raters and a second time span for defining the time length given to raters in order for them to provide feedback for to the object depiction; and for communicating the object depiction and the presentation scheme selected for it, to the rater devices which details were retrieved;
one or more rater modules, installed or integrated into at least the rater devices for which identity details were retrieved, for receiving the object depiction and the presentation scheme selected for it from said system server, presenting the received object depiction and a rater feedback interface in accordance with the first and the second timespans, respectfully; and communicating rater feedbacks to the object depiction, where provided, to said system server; said system server, for receiving multiple rater feedbacks to the object depiction, where provided, form said rater modules, for generating one or more joint impression parameters based on the received multiple feedbacks; and for communicating the joint impression parameters to said user module; and
said user module for presenting to the user an object impression evaluation for the uploaded object depiction, wherein the object impression evaluation at least partially includes, or is at least partially based on, the joint impression parameters.

2. The system of claim 1, wherein said user module further includes an attribute selection logic for receiving a designation of one or more attributes of the acquired object depiction, for rater evaluation.

3. The system of claim 2, wherein said attribute selection logic presents to the user a predefined set of two or more optional object depiction attributes to choose and designate from.

4. The system of claim 3, wherein said system server is further adapted to process the acquired object depiction to highlight one or more of the object attributes designated by the user.

5. The system of claim 4, wherein the object depiction includes an image and wherein highlighting user designated attributes at least partially includes degradation of the depiction image or parts thereof, prior to its communication to raters, to emphasize the designated attributes.

6. The system of claim 1, wherein receiving user definitions for the selection of one or more raters includes presenting for user selection at least a rater's age constraint interface element, a rater's place of residence constraint interface element or a rater's gender constraint interface element.

7. The system of claim 1, wherein the depiction presentation scheme includes instructions for presentation of a rater notification preparing the rater to the presentation of the object depiction, wherein the notification is presented to the rater just prior to the beginning of the first time span.

8. The system of claim 7, wherein the first time span is shorter than 5 seconds.

9. The system of claim 1, wherein the depiction presentation scheme includes instructions for presentation of an initial set of placebo object depictions for rater's rating, prior to the presentation of the actual user uploaded object depiction for his rating.

10. The system of claim 1, wherein generating the joint impression parameters based on the received multiple feedbacks, includes allocating different weights to at least some of the associated raters' feedbacks based on the rating history of their respective raters.

11. The system of claim 1, wherein generating the joint impression parameters at least partially includes a calculation of combined rater-specific impression parameters, while taking into account a combination of: an initial rater's rating value for the current object depiction, the response time it took the rater to provide the current feedback and the response pressure applied by the rater as part of providing the current feedback.

12. The system of claim 11, wherein the calculation of combined rater-specific impression parameters further includes taking into account an average response pressure applied by the current rater or an average response time taken by the current rater.

13. The system of claim 1, wherein said system server includes an Internet bot applied for inviting potentially relevant raters to rate a specific object depiction for which the system determined that additional raters are needed.

14. The system of claim 13, wherein said system server determines that additional raters are needed for the rating of the specific object depiction, based on the accumulated rater-specific impression parameters not reaching or passing a statistical threshold value, or not showing an asymptotic behavior—once a certain predetermined number of ratings have been received.

15. The system of claim 1, wherein said system server is adapted to generate perceived object depiction ratings without human intervention, at least partially based on logged raters' feedback history pertaining to prior object depictions.

16. The system of claim 15, wherein logged raters' feedback history is statistically analyzed for generating perceived object depiction ratings.

17. The system of claim 15, further including a neural network model, wherein logged raters' feedback history is used as training data for said neural network model and once trained the model is utilized for generating perceived object depiction ratings.

18. A method for impression measurement and evaluation, said method comprising:
receiving from a user device an acquired object depiction;
receiving from the device user definitions for the selection of one or more raters for providing feedback to the object depiction;
referencing a database containing records of candidate raters and retrieving identity details of one or more rater devices associated with candidate rater details matching the received user definitions;
selecting a depiction presentation scheme, wherein the presentation scheme includes at least a first time span for defining the time length of presentation of the depiction to raters and a second time span for defining the time length given to raters in order for them to provide feedback for to the object depiction;
presenting the received object depiction and a rater feedback interface over the one or more rater devices for which device identities were retrieved, in accordance with the first and the second timespans, respectfully;
receiving multiple rater feedbacks to the object depiction;
generating one or more joint impression parameters based on the received multiple feedbacks; and
presenting over the user device an object impression evaluation for the uploaded object depiction, wherein the object impression evaluation at least partially includes, or is at least partially based on, the joint impression parameters.

19. A mobile computerized communication device, said device including:
a face recognition device login system; and
a system for impression measurement and evaluation, including:
a user module installed or integrated into said mobile computerized communication device for uploading an object depiction to a system server;
said system server for referencing a database containing records of candidate raters and retrieving identity details of one or more rater devices and for selecting a depiction presentation scheme, wherein the presentation scheme includes at least a first time span for defining the time length of presentation of the depiction to raters and a second time span for defining the time length given to raters in order for them to provide feedback for to the object depiction; and for communicating the object depiction and the presentation scheme selected for it, to the rater devices which details were retrieved;
one or more rater modules, installed or integrated into at least the rater devices for which identity details were retrieved, for receiving the object depiction and the presentation scheme selected for it from said system server, presenting the received object depiction and a rater feedback interface in accordance with the first and the second timespans, respectfully; and communicating rater feedbacks to the object depiction, where provided, to said system server;
said system server, for receiving multiple rater feedbacks to the object depiction, where provided, form said rater modules, for generating one or more joint impression parameters based on the received multiple feedbacks; and for communicating the joint impression parameters to said user module; and
said user module for presenting to the user an object impression evaluation for the uploaded object depiction, wherein the object impression evaluation at least partially includes, or is at least partially based on, the joint impression parameters; and wherein said system for impression measurement and evaluation has access to images acquired, as part of a user device login process executed by said face recognition device login system; and is adapted for automatically uploading images acquired by said face recognition device login system, as object depictions for impression measurement and evaluation.
